(19) United States
(12) Patent Application Publication
(10) Pub. No.: US 2023/0030711 A1
(43) Pub. Date: Feb. 2, 2023

(54) SMART TRAINING ACCESSORY FOR MUSICAL INSTRUMENTS

(71) Applicants: Lucille Vinkel, Vanløse (DK); Iben Glassow Jepsen, COPENHAGEN (DK); David Hald, Greve (DK); MURAD HAMAD MAHMOUD, COPENHAGEN (DK)

(72) Inventors: Lucille Vinkel, Vanløse (DK); Iben Glassow Jepsen, COPENHAGEN (DK); David Hald, Greve (DK); MURAD HAMAD MAHMOUD, COPENHAGEN (DK)

(21) Appl. No.: 17/850,012

(22) Filed: Jun. 27, 2022

Related U.S. Application Data
(60) Provisional application No. 63/179,652, filed on Apr. 26, 2021.

(51) Int. Cl. G09B 15/02; G09B 15/00

(52) U.S. Cl. CPC G09B 15/023; G09B 15/002

(57) ABSTRACT

A smart training accessory connected to musical instrument for aiding users in learning and collaboration is disclosed. The accessory includes a plurality of sensors for collecting data pertaining to the musical instrument. A microcontroller processes the data collected by the plurality of sensors to: (a) determine a type of musical instrument to which the smart training accessory is connected and (b) generate an alert for encouraging an individual to play the musical instrument when the user enters a monitoring area within the vicinity of the smart training accessory. Furthermore, when the user plays the musical instrument, the plurality of sensors captures data including audio recordings and transmits the data to a training and synchronization system. The training and synchronization system processes the received data to generate real-time feedback for the user and further aids collaboration with other users.

### CROSS-REFERENCE TO RELATED APPLICATIONS

This application claims the benefit of U.S. Provisional patent application Ser. No. 63/179,652 entitled, “Training Accessory for Instruments”, filed Apr. 26, 2021, which is incorporated herein in its entirety.

### FIELD OF THE INVENTION

The present disclosure relates to the field of training accessories. More particularly, the present invention is related to a training accessory that may be used with instruments such as musical instruments and sporting instruments for aiding users in learning and virtual collaboration.

### BACKGROUND OF THE INVENTION

When it comes to learning musical instruments, nothing beats the learning strategy of regular and systematic practice. Collaborating with other musicians is another strategy for improving one's skillsets. While these strategies are well known for most players, the practical difficulty in implementing them makes learning slow and cumbersome for many aspiring musicians. It is well established that sticking to a specific time schedule and being reminded of the learning strategy constantly will help in improving the learning curve.

Several technological solutions have been proposed over the years to help aspiring musicians learn instruments more effectively. This includes inbuilt training programs in pianos, third party software applications with structured training programs, and the like. While these solutions allow users to increase their learning efficiency, they are mostly inbuilt to specific musical instruments and may not be available to use for multiple musical instruments. For example, modern day electronic pianos generally have inbuilt recording and training software. This facility may not be available for a violin or a guitar mostly due to the design of the instrument and the inherent limitations with respect to their playing style.

U.S. Ser. No. 10/825,432B2 discloses a smart musical instrument system for replaying user performance with auto-play, electronic sound source or video, the system may include a musical instrument, a plurality of sensors, and a processing device. The plurality of sensors may be configured to obtain performance data of a user. The plurality of sensors may include a first sensor configured to obtain first performance data of the user. The performance data may include the first performance data indicating operations of a musical instrument. The processing device may be in communication with the plurality of sensors. The processing device may be configured to compare the performance data with reference music data to generate a comparison result and generate feedback based on the comparison result.

U.S. Pat. No. 8,809,662B2 discloses a musical performance training apparatus, a musical performance training method, and a computer readable medium. The a musical performance training apparatus includes a receiver, a calculator, a storage controller, an evaluator and an advice generator. The receiver receives note data of a musical sound supplied according to operation of a musical performance manipulandum by a player. The calculator calculates the musical performance operation frequency based on the note data received by the receiver every predetermined period of time elapsed. The storage controller stores the musical performance operation frequency each time calculated by the calculator in a predetermined memory and the said musical performance operation frequency is associated with any one of a plurality of practice forms. The evaluator evaluates a motivation change and a musical performance technique level change of the player based on a latest musical performance operation frequency stored in the memory and a musical performance operation frequency which is stored in the memory before the latest musical performance operation frequency is stored, for each of identical practice forms. The an advice generator generates advice based on the motivation change and the musical performance technique level change thus evaluated for each of the practice forms.

US20140076123A1 discloses an apparatus for calculating a practice time. The apparatus is used by a user to calculate such practice time that he/she requires to improve his/her playing technique to reach a predetermined progressing level at the playing technique. In the apparatus, a progressing-level evaluating unit evaluates a progressing level of a playing technique of the user who operates a playable unit. A history of the evaluated progressing level is recorded in a progressing-level recording unit. An operation-number counting unit counts the number of operations executed on the playable unit by the user every unit time. A history of the counted number of operations is recorded in an operation-number recording unit. A practice-time calculating unit calculates the practice time based on the history of the progressing level recorded in the progressing-level recording unit and the history of the number of operations recorded in the operation-number recording unit.

U.S. Pat. No. 6,482,087B1 discloses a method for providing real-time musical interaction among a plurality of players connected via a network includes the steps of analyzing local player's musical performance to extract emulation data that represents the musical performance; transmitting emulation data to remote players over a network; receiving emulation data from remote players over the network; and using the emulation data to emulate the remote player's musical performance by locally generating approximations of the performances.

U.S. Pat. No. 6,653,545B2 discloses a system for permitting participants to collaborate in the performance of music, i.e. to jam, where any performer may be remote from any others. As per the disclosed invention, each musician has a station, typically including a keyboard, computer, synthesizer, and a communication channel. The communication channel might be a modem connected to a telephone line, a DSL connection, or other local, wide, or Internet network connection. When musicians desire a jam session, their respective station computers communicate with each other, or perhaps with a designated host computer, and determine the communication delays to and from each other station in the jam. Subsequently, each musician's performance is immediately transmitted to every other musician's station. However, the performance is delayed before being played locally. Upon receipt, remote performances are also delayed, with the exception of the performance coming from the station having the greatest associated network delay, which can be played immediately. The local performance is played locally after undergoing a delay equal to that of the greatest associated network delay. By this method, each musician's local performance is kept in time with every other musician's performance. The added delay between the musician's performance and the time it is played, becomes an artifact of the instrument. As such, the musician is able to compensate for it and “play ahead” or “on top of” the jam beat.

U.S. Pat. No. 9,236,039B2 discloses technologies for a virtual instrument playing system. In some examples, a virtual instrument playing system may include a sensor data receiving unit configured to receive first sensor data of a first user and second sensor data of the first user, a sound event prediction unit configured to detect a sound event of the first user and to predict a sound generation timing corresponding to the sound event of the first user based at least in part on the first sensor data of the first user, an instrument identification unit configured to identify a virtual instrument corresponding to the sound event from one or more virtual instruments based at least in part on the second sensor data of the first user, a sound data generation unit configured to generate sound data of the first user regarding the identified virtual instrument based at least in part on the sound generation timing, and a video data generation unit configured to generate video data of the first user regarding the identified virtual instrument based at least in part on the second sensor data of the first user.

Innovators around the world have come up with several solutions to help aspiring musicians learn instruments in a more efficient way. The wide range of patents related to this field shows the scope of innovation in this technical field. While the prior arts solve specific problem of learning and collaboration, they generally are restricted to a single instrument. Moreover, the solutions provided by the prior arts are not portable or easy to adapt. Hence, there existed a need for a simple plug and play device that may be used with multiple musical instruments to help users in training and collaboration. The present invention tries to solve this technical problem by proposing a smart technical accessory that can be operated with a wide range of musical instruments thereby overcoming the drawbacks of the prior arts. The smart technical instrument can be either in-built or portable.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present invention discloses a smart training accessory that may be attached to a wide range of musical instruments. The smart training accessory may have a plurality of sensors inbuilt to it allowing it to detect the type of musical instrument to which it is connected. The accessory may be configured to automatically determine the presence of a user near the instrument and nudges the user to play the instrument. Further, the accessory may be communicatively connected to a network computing system running a software for allowing the users to communicate and collaborate with other musicians. The accessory may be a smart accessory that determines the user who is playing the instrument and provides appropriate feedback based on the user's competence. The accessory may aid users in learning musical instruments more effectively and further allows virtual collaboration among musicians.

In another related embodiment, a smart training accessory connected to musical instrument for aiding a user in learning and virtual collaboration with other users. The accessory comprises a plurality of sensors and a microcontroller. The plurality of sensors are used for collecting data pertaining to the musical instrument. The microcontroller comprises a processor and memory. This microcontroller processes the data collected by the plurality of sensors and generate an alert which encourages the user to play the musical instrument when the user enters a monitoring area within the vicinity of the smart training accessory. When the user plays the musical instrument, the plurality of sensors captures data including audio recordings and transmits the data to a training and synchronization system. The training and synchronization system processes the received data from the plurality of sensors to generate real-time feedback for the user. Additionally, the training and synchronization system allows the user to collaborate with other users using the smart training accessory as it is communicatively connected to smart training accessory of other users. The processed data of the user is shared with other users by the training and synchronization system.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is an exemplary depiction of a musical instrument with the proposed training accessory attached to it according to the embodiments of the present disclosure.

FIG. 2 is an exemplary block diagram of the architecture of the training and synchronization system (server side) according to the embodiments of the present disclosure.

FIG. 3 is an exemplary block diagram of the architecture of the client side (musical instrument apparatus) according to the embodiments of the present disclosure.

FIG. 4 is an exemplary block diagram of the core operating modules of the present disclosure.

The drawings described herein are for illustration purposes only and are not intended to limit the scope of the present subject matter in any way.

### DETAILED DESCRIPTION

Embodiments described herein discloses a smart training accessory connected to musical instrument for aiding a user in learning and virtual collaboration with other users. The accessory comprises a plurality of sensors and a microcontroller. The plurality of sensors are used for collecting data pertaining to the musical instrument as well as the user. The plurality of sensors captures data pertaining to the type of musical instrument the smart accessory is connected to. The microcontroller comprises a processor and memory. This microcontroller processes the data collected by the plurality of sensors and generate an alert which first encourages the user to play the musical instrument when the user enters a monitoring area within the vicinity of the smart training accessory. When the user plays the musical instrument, the plurality of sensors again capture data including audio recordings and transmits the data to a training and synchronization system. The training and synchronization system then processes the received data from the plurality of sensors to generate real-time feedback for the user. Additionally, as the training and synchronization system is communicatively connected to smart training accessory of other users, it allows the user to collaborate with other users using the smart training accessory.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items. Furthermore, the terms “monitoring area”, “pre-defined area”, and “range” may be used interchangeably throughout this document. Moreover, the terms “smart training accessory”, “musical instrument accessory”, “accessory”, “apparatus” and “training accessory” may be used interchangeably throughout the document. Furthermore, the terms “user”, registered user” and “individuals” may be used interchangeably throughout the document. The server side that is configured to process the data sent by the client device and perform other operations that will be explained in the foregoing sections of this disclosure may be referred to as “training and synchronization system” or “server” interchangeably. The terms used herein do not restrict the scope of the present invention. The terms used herein cover all possible technical solutions as understood by a person skilled in the art.

Unless otherwise defined, all terms (including technical and scientific terms) used herein have the same meaning as commonly understood by one of ordinary skill in the art to which this disclosure pertains. It will be further understood that terms, such as those defined in commonly used dictionaries should be interpreted as having a meaning that is consistent with their meaning in the context of the relevant art and will not be interpreted in an idealized or overly formal sense unless expressly so defined herein.

The present disclosure proposes a smart training accessory that may be attached to any musical instrument. The accessory may have a plurality of sensors such as microphones, location sensor, bluetooth sensor, infrared sensor, light detection sensor, accelerometer, gyro sensor, and the like. The plurality of sensors allows the accessory to detect the type of musical instrument to which it is connected. The accessory may be configured to automatically determine the presence of a specific user near the instrument and nudges the user to play the instrument. That is, the accessory may determine if a registered user comes near the instrument. It may not alert every individual who comes near the instrument thereby avoiding false alarms. Once a specific user is detected, the accessory nudges the specific user. The apparatus may comprise of a light based alerting system and a sound based alerting system. When the apparatus detects a user it may blink and/or make a sound to seek the attention of the user. This alert may encourage the user to play the instrument. Once the user starts playing the instrument, the sensors again capture the data related to the performance and sends the data to a training and synchronization system on the server side. Once the training and synchronization system receives the date, processor of the synchronization system processes the received data, to generate a real time feedback. This real time feedback is provided to the user and also to other users who are connected by a network with the training and synchronization system. This allows the user to co-ordinate with other users using the smart training accessory.

A registered user is someone who has a wearable device that is configured or connected with the accessory. The wearable device can be a smart watch, a fitness band or the like which sends signals for the sensors to identify the registered user. Alternatively, the user is connected to the smart training accessory through his smart phone will also be a registered user.

The accessory may further have a timer inbuilt to it which calculates the amount of time specific users play/use the instrument to which the accessory is attached to. In one example, the timer may get activated upon the user picking up a musical instrument or starts using a device the accessory is attached to. In another example, the timer may be configured to calculate the total amount of time a specific user uses the instrument. That is, while the timer activates upon the user picking the instrument, it may calculate time periods only based on actual playing/usage. In one example, the timer may not start if a random user (unregistered profile) uses the instrument.

Further, the accessory may be communicatively connected to a network computing system running a software for allowing the users to communicate and collaborate with other musicians who use the accessory. The accessory may be a smart accessory that determines the user who is playing the instrument and provides appropriate feedback based on the user's competence. The accessory may aid users in learning musical instruments more effectively and further allows virtual collaboration among musicians. The apparatus may gather data and transmit them to a server side which processes the data and performs a wide variety of operations. The accessory may have its own microcontroller which comprises both processor and memory, capable of performing a specific set of functions by itself. In one example, the accessory may detect users coming nearby and alert them by itself without depending on the server side. One the other hand, the apparatus may transmit data for further processing for performing operations like aiding virtual collaboration, providing feedback to the user, determining proficiency of user, profiling a user, and the like.

In one example, the training accessory described herein wirelessly monitors users at a defined area. Herein the accessory may have a pre-defined monitoring area, any registered user who enters this area is identified by the training accessory. Upon identifying the registered user, the accessory generates visual and/or audio alerts to seek the attention of the registered user. The accessory may either detect the presence of the user by means of object detection sensors, temperature sensors, audio sensors, light sensors, movement detection sensors, and the like, or by detecting a paired personal electronic device such as a smartphone or a smartwatch that the user constantly carries. The accessory may have components that emit wireless signals such as Bluetooth, Wi-Fi, IR, or any other radio waves. The radio waves used herein may be referred to as “signals” throughout this document, the term used herein does not limit the scope of the invention in any form.

The utility of the devices described herein will be explained further in detail in the following sections of this document referring to the figures.

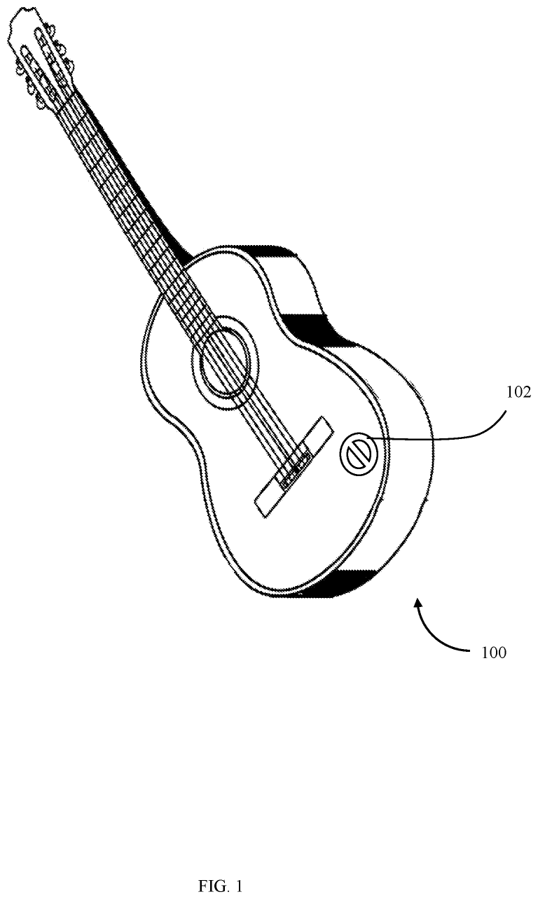

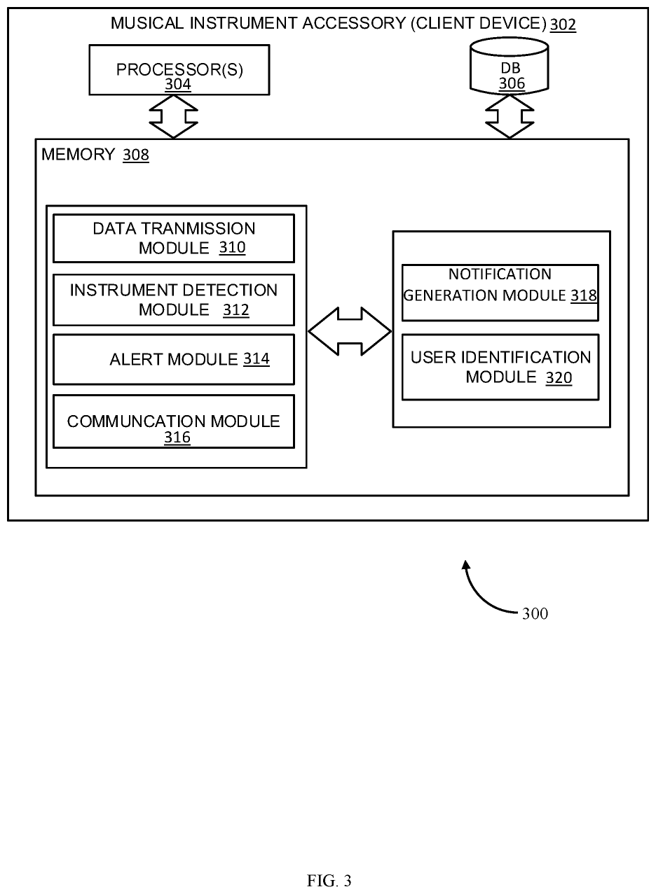

Referring to the figures, FIG. 1 is an exemplary depiction 100 of a musical instrument with the proposed apparatus 102 attached to it according to the embodiments of the present disclosure. The musical instrument depicted here is a Guitar, it may be understood that the accessory 102 may be attached to a wide variety of musical instrument as understood by a person skilled in the art. The accessory 102 constantly checks for presence of a user nearby and sends an alert upon detecting a user. Furthermore, the accessory 102 may also be configured to maintain user profiles to provide specific training and suggestions to each user. As discussed earlier, the accessory 102 may have a plurality of sensors. A light source for providing visual cues and a speaker for providing audio cues may be provided. The accessory 102 may further comprise its own processor, memory and database. The architecture of the accessory will be discussed in detail while explaining FIG. 3.

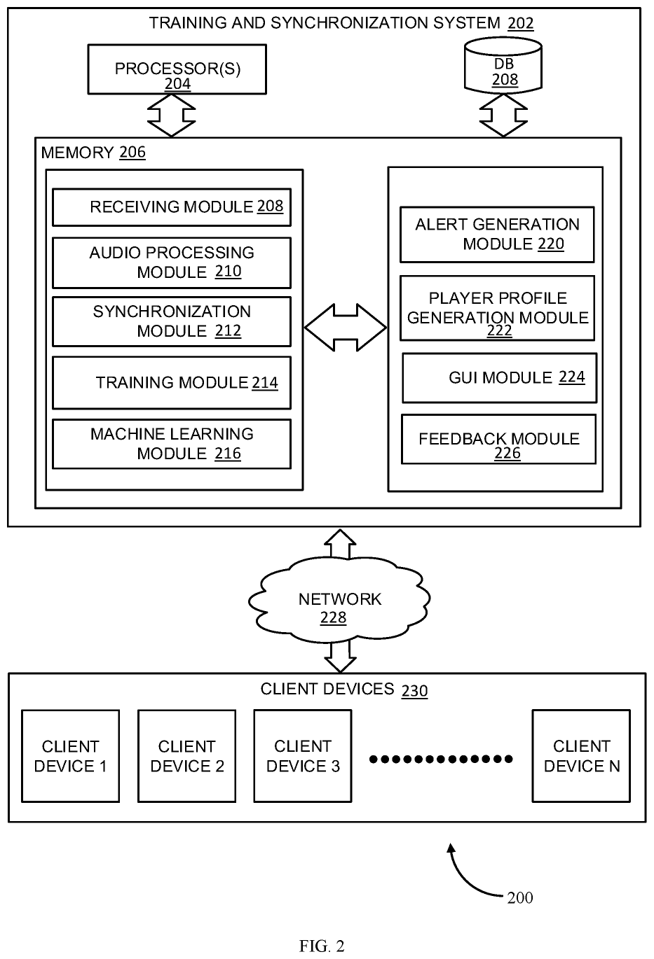

FIG. 2 is an exemplary block diagram 200 of the architecture of the training and synchronization system 202 (server side) connected to a plurality of client devices 238 (accessories) via a network 228. As shown in FIG. 1, the training and synchronization system 202 may include processor(s) 204 and memory 206 that are communicatively coupled to each other. Further, the training and synchronization system 202 may include a database (DB) 218 that may be communicatively connected to the memory. Furthermore, as shown in FIG. 1, memory 206 may include a receiving module 208, an audio processing module 210, a synchronization module 212, a training module 214, a machine learning module 216, an alert generation module 220, a player profile generation module 222, Graphical User Interface (GUI) management module 224, and a feedback module 226. One or more client devices 238, 232, 234, 236 may be communicatively connected to the training and synchronization system.

Components of the training and synchronization system 202 may be any combination of hardware and programming to implement the functionalities described herein. In some implementations, the programming may be processor 204 executable instructions stored on a non-transitory machine-readable storage medium (e.g., memory 206), and the hardware may include at least one processing resource to retrieve and/or execute those instructions. Processor(s) 204 may include, but are not limited to, one or more digital signal processors (DSPs), one or more microprocessor 204, one or more special-purpose computer chips, one or more field-programmable gate arrays (FPGAs), one or more application-specific integrated circuits (ASICs), one or more computer(s), various analog to digital converters, digital to analog converters, and/or other support circuits. Processor(s) 204 thus may also include the functionality to encode messages and/or data or information. Processor(s) 204 may include, among other things, a clock, an arithmetic logic unit (ALU), and logic gates configured to support the operation of processor(s). Further, the processor(s) 204 may include functionality to execute one or more software programs, which may be stored in the memory 206 or otherwise accessible to processor(s) 204.

Memory 206, may store any number of pieces of information, and data, used by the system to implement the functions of the system. The memory 206 may include, for example, volatile memory and/or non-volatile memory. Examples of volatile memory may include but are not limited to volatile random-access memory (RAM). The non-volatile memory may additionally or alternatively comprise an electrically erasable programmable read-only memory (EEPROM), flash memory, hard drive, and the like. Some examples of volatile memory include, but are not limited to, dynamic RAM, static RAM, and the like. Some example of the non-volatile memory includes, but are not limited to, hard disks, magnetic tapes, optical disks, programmable read-only memory, erasable programmable read-only memory, electrically erasable programmable read-only memory, flash memory, and the like. Memory may be configured to store information, data, applications, instructions, or the like for enabling the system to carry out various functions in accordance with various example embodiments. Additionally, or alternatively, the memory may be configured to store instructions which when executed by processor(s) cause the training and synchronization system to behave in a manner as described in various embodiments.

In one implementation, the network 228 may be a wireless network, a wired network, or a combination thereof. Network 228 may be implemented as one of the several types of networks, such as intranet, local area network (LAN), wide area network (WAN), the internet, and the like. Network 228 may either be a dedicated network or a shared network. The shared network represents an association of the several types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 228 may include a variety of network devices, including routers, bridges, servers, computing devices, storage devices, and the like.

During the operation, the receiving module 208 may receive data from the client devices 238. Data may include audio captured by the microphone, data from the plurality of sensors, and the like. The audio processing module 210 may process the audio data received from the client device 230 to generate useful information. Audio received from the client device 230 may include recordings (live or cached) audio recordings of the user playing the instrument. The audio processing module 210 processes these audio signals in real-time and determines information including the user who is playing the instrument, type of instrument played, proficiency level of the user, and the like.

The synchronization module 212 synchronizes audio signals received from multiple client devices 238 during a collaborative session. The training module 214 provides users with valuable training data via a connected electronic device having a display unit. The machine leaning module 216 determines learning curve of each user and provides smart suggestions and feedback via the feedback module 226. User profiles are generated and maintained by the players profile generation module 222. Alert generation module 220 may be used to send notifications to other connected client devices 238 or electronic devices. Herein, the alert generation module 220 provides information to electronic devices of different users by means of notifications. Individuals using the accessory may be allowed to form interest groups via a supporting software application to collaborate and communicate with each other. In one example, when one user picks up his/her instrument, the alert generation module 220 may send a notification to other users of the interest group thereby encouraging the users to practice and/or collaborate.

FIG. 3 is an exemplary block diagram 300 of the architecture of the client side (musical instrument accessory) communicatively connected to the training and synchronization system 202. The musical instrument accessory 302 corresponds to one of the client device 230 of FIG. 2. The musical instrument accessory 302 may also comprise processor(s) 304 communicatively connected to a memory 308 and a database 306. Memory 308 may include a data transmission module 310, an instrument detection module 312, an alert module 314, a communication module 316, a notification generation module 319, and a user identification module 320.

During operation, the data transmission module 310 may transmit audio, sensor data, and other output generated by the musical instrument accessory 302 to the training and synchronization system 202. All communication to and from the musical instrument accessory 302 is managed by the communication module 316. The instrument detection module 312 detects the instrument to which the accessory 302 is connected. The alert module 314 alerts users who come nearby the musical instrument by via visual and audio means. The notification generation module 318 sends information to the server side, training and synchronization system 202 for notifying instrument usage to interest groups via connected electronic devices.

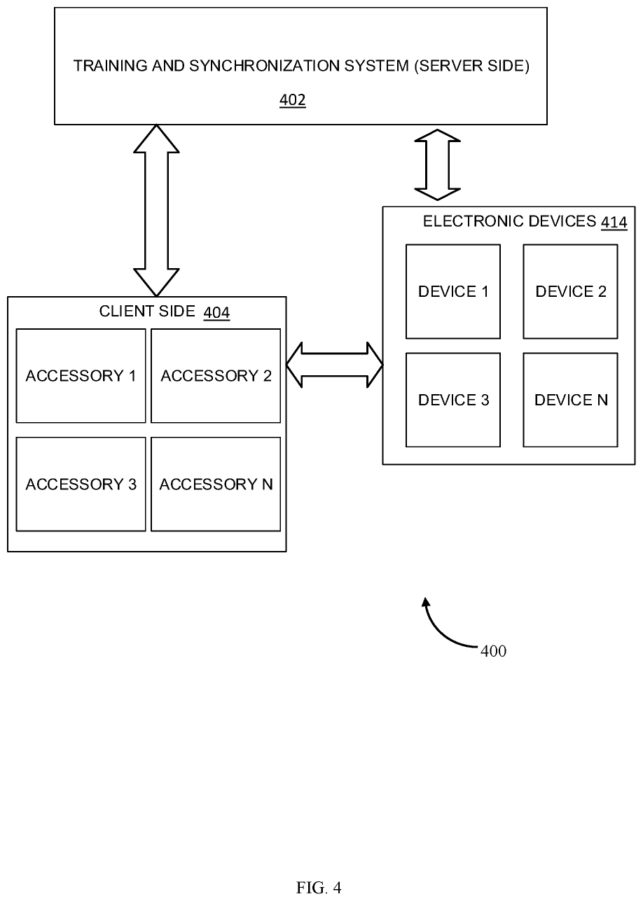

FIG. 4 is an exemplary block diagram 400 of the core operating modules of the present disclosure. The module includes the server side, training and synchronization system 402 where complex processing takes place, client side 404 (accessory) connected to the server 402, and electronic devices 414 connected to the server side 402 and client side 404 to interact with the users via supporting software applications. The server side 402 and the client side 404 provides instructions and communicates directly with the users via the display unit of the electronic devices 414.

The accessories in the client side 404 allow users to collaborate virtually wherein the microphone of the accessory or a secondary conference microphone is used to enable collaboration. Audio is recorded and transmitted to the server side 402 where it is processed and synchronized in real time. The output may be provided to the users via their connected electronic devices 414. The software application provided in the electronic devices 414 may also allow editing and publication of the recorded collaborative work. Furthermore, a decibel meter may be provided within the accessories in client side 404 to identify the properties of the tones generated by musical instruments to aid users in tuning them.

Essentially, the accessory and the related embodiment provides the following technical solutions to the users:

1. Reminders—Upon detecting users nearby, the accessory blinks and/or generates audio alerts to seek the user's attention and encourages them to play the instrument.

2. Training—The accessory tracks the amount of time each user plays the instrument and provides smart recommendation. Users are provided information about the total amount of time they played the instrument, their learning curve, real time feedback, and the like. Reminders to play the instrument are also provided to the user.

3. Collaboration—The accessory and related embodiment allow virtual collaboration. Herein, audio is recorded in real-time from multiple users/instruments and synchronized.

4. Application support—The software application allows users to create interest groups and learn together. It further aids in training and collaboration. The application may also generate smart notifications to encourage users to train and learn more effectively. The application further gathers data automatically upon detecting the user who is playing the instrument. Past data is gathered and useful suggestions are provided in real time. The machine learning module in the server side learns user activity and behaviour over a period of time to generate efficient tips for improving the skills of the user.

Furthermore, the accessory can also be used with devices that require motivation and practice from the user's behalf. Apart from musical instrument, the accessory may also be attached to sporting equipment like cycles, treadmills, or other related devices that requires the user to make use of them for regularly to gain the required effects. To summarize, the accessory may be used as a motivating/reminding tool with any device that required motivation from the user's behalf. The device may be attached to sound mixers so that DJs can make use of their gadgets more efficiently by collaborating. It may also be attached with microphones or related sound recording/processing equipment to help singers practice and collaborate. Apart from musical instruments, it may be used with bicycles, fitness equipment, and other related sporting goods/products to motivate the user by means of its blinking/reminder functionality. The use case of the abovementioned accessory is not restricted to the abovementioned scenarios alone. The accessory may be used along with any equipment that requires reminder/motivating features and/or collaboration among users. The present disclosure covers all related use cases as understood by a person skilled in the art.

In one exemplary embodiment, the accessory, upon determining the user who is using the instrument and determining the amount of usage, notifies collaborators or related users via their electronic devices. That is, user profiles and connected profiles paired with each accessory may receive notification regarding the usage and usage statistics in real-time. In one example, if user A picks up an instrument, connected users B, C and D may receive notifications informing that user A is using the instrument. This may provide motivation to collaborating users. The notification may be provided directly to the electronic device of other users or via signals (such as nudges and sound signals) to the connected accessories within the network.

With such notifications, connected users may be motivated to use their instruments upon realizing that their peer is using the instrument. Moreover, this feature may be used by parents/guardians of children to make sure that their wards are practicing. This feature may also be used as a monitoring/safety feature by guardians.

The timer of the accessory monitors instrument usage and transfers the data to a database that connected to an application. Users may receive insights such as statistics about their usage upon picking their instrument. Users may also be allowed to predefine usage targets. The accessory may directly, or via the connected application, remind the users of their goals and further support gamification features by providing rewards upon completing each goal. In one example, lights and sounds may be used by the accessory to denote completion/non-completion of an achievement via the accessory. Such notifications may also be provided via the connected software application installed in an electronic device.

In one embodiment, the accessory may be portable and may be connected to any supporting device/instrument. In another embodiment, the accessory may be inbuilt to an instrument such as an electric guitar, a piano, or a treadmill.

In yet another exemplary embodiment, the accessory may monitor the usage of the connected instrument over time via its timer and related sensors to determine maintenance requirements of the instrument/device to which it is connected. In one example, the accessory may determine the amount of time a guitar string is used to determine if replacement strings are to be ordered. The accessory may notify the user about such requirements regularly. In another example, the connected application may automatically order replacement accessory upon reaching a predetermined set of conditions related to each component of the instrument/device. That is, 100 hours may be set as a pre-defined condition for the longevity of guitar strings. Upon reaching this target, the accessory may notify the user regarding replacement schedule. The connected application may allow users to automate the process of ordering replacement as well. Similarly, predefined values may be set for different components of a plurality of instruments/devices as understood by a person skilled in the art.

Examples described herein can also be used in various other scenarios and for various purposes. It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The present description has been shown and described with reference to the foregoing examples. It is understood, however, that other forms, details, and examples can be made without departing from the spirit and scope of the present subject matter.

What is claimed is:

1. A smart training accessory connected to musical instrument for aiding a user in learning and collaboration, comprising:
a plurality of sensors for collecting data pertaining to the musical instrument;
a microcontroller comprising a processor and a memory, wherein the microcontroller processes the data collected by the plurality of sensors to:
determine a type of musical instrument to which the smart training accessory is connected; and
generate an alert for encouraging an individual to play the musical instrument when the user enters a monitoring area within the vicinity of the smart training accessory; and
upon the user playing the musical instrument, the plurality of sensors captures data including audio recordings and transmits the data to a training and synchronization system, wherein the training and synchronization system processes the received data to:
generate real-time feedback for the user; and
allow the user to collaborate with other users using the smart training accessory.

2. The smart training accessory of claim 1, wherein the smart training accessory is inbuilt in the musical instrument.

3. The smart training accessory of claim 1, wherein the smart training accessory is portable.

4. The smart training accessory of claim 1 wherein the plurality of sensors include microphones, location sensor, proximity sensors, wireless communication sensors, light detection sensor, accelerometer, gyro sensor, humidity detection sensor, and temperature detection sensors.

5. The smart training accessory of claim 4, wherein the smart training accessory transmits the data collected by the plurality of sensors including audio captured by the microphones to the training and synchronization system.

6. The smart training accessory of claim 5, wherein the audio captured by the microphone is processed by the training and synchronization system to determine and notify tuning issues in the musical instrument.

7. The smart training accessory of claim 5, wherein the training and synchronization system is communicatively connected to smart training accessory of other users.

8. The smart training accessory of claim 7, wherein the training and synchronization system directs the smart training accessory of other users to generate an alert.

9. The smart training accessory of claim 4, wherein the training and synchronization system detects and notifies anomalies in temperature and humidity.

10. The smart training accessory of claim 1, wherein the smart training accessory includes a timer for calculating the amount of time the user plays the musical instrument.

11. The smart training accessory of claim 10, wherein the timer activates when the user picks the musical instrument.

12. The smart training accessory of claim 10, wherein the timer system starts calculating time when the user starts playing the instrument.

13. The smart training accessory of claim 10, wherein the training and synchronization system notifies the user to replace one or more components of the musical instruments based on the amount of time the user played the musical instrument, wherein the one or more component includes at least one of strings, keys, bows, bridges, tuning pegs, bridge pins, or buttons.

14. The smart training accessory of claim 1, wherein the alerts are light based or sound based.

15. The smart training accessory of claim 1, wherein a user electronic device paired with the smart training accessory allows the smart training accessory to identify a registered user.

16. The smart training accessory of claim 15, wherein the electronic device is a smartphone or a wearable device.
